(19) United States
(12) Patent Application Publication
(10) Pub. No.: US 2023/0302825 A1
(43) Pub. Date: Sep. 28, 2023

(54) MOUNTING SYSTEMS FOR PRINT MEDIUM SUPPORTING STRUCTURES

(71) Applicant: Hewlett-Packard Development Company, L.P., Spring, TX (US)

(72) Inventors: Isidoro MAYA AGUDO, Sant Cugat del Valles (ES); Ricardo SANCHIS ESTRUCH, Sant Cugat del Valles (ES); Jordi ALBERT GINE, Sant Cugat del Valles (ES)

(73) Assignee: Hewlett-Packard Development Company, L.P., Spring, TX (US)

(21) Appl. No.: 17/996,585

(22) PCT Filed: Apr. 20, 2020
(86) PCT No.: PCT/US2020/028910

§ 371 Date: Oct. 19, 2022

(51) Int. Cl. B41J 11/20; F16M 11/18; F16M 11/12; B41J 11/00

(52) U.S. Cl. CPC B41J 11/20; F16M 11/18; F16M 11/12; B41J 11/007

(57) ABSTRACT

Disclosed herein is a mounting system for mounting a print medium supporting structure in a printing device, a printing device and a method of operating a printing device. The mounting system comprises a carrier assembly that is to carry the supporting structure. The carrier assembly comprises a bushing element to movably mount the carrier assembly on a guiding rod in the printing device. The bushing element comprises a first bushing that is to slidably receive the guiding rod and to allow for a tilting motion of the carrier assembly relative to the guiding rod around a first axis perpendicular to the guiding rod. The carrier assembly further comprises a flexible element to couple the supporting structure to the carrier assembly. The flexible element is to allow for a tilting motion of the supporting structure relative to the carrier assembly around a second axis different from the first axis.

### BACKGROUND

A printing device like an ink-jet printer may comprise a supporting structure to support a print medium in a print zone of the printing device. The printing device may further comprise a printing unit such as a print head that is to deposit a printing fluid such as ink on the print medium in the print zone, wherein the support structure may be to advance the print medium along a media advance direction.

### BRIEF DESCRIPTION OF DRAWINGS

In the following, a detailed description of various examples is given with reference to the figures. The figures show schematic illustrations of

FIG. 1a: a cross section of a mounting system according to an example in side view along a first axis;

FIG. 1b: a cross section of the mounting system of FIG. 1a in side view along a second axis in accordance with an example;

FIG. 2: a bushing element with two bushings according to an example in an exploded view;

FIG. 3: a mounting system comprising the bushing element of FIG. 2 in accordance with an example in an exploded view;

FIG. 4a: a printing device according to an example in top view;

FIG. 4b: a cross section of the printing device of FIG. 4a in side view in accordance with an example;

FIG. 5a: a supporting structure and a guiding system of a printing device according to an example in a perspective view;

FIG. 5b: the supporting structure and the guiding system of FIG. 5a in top view in accordance with an example; and

FIG. 6: a method of operating a printing device according to an example.

### DETAILED DESCRIPTION

In a printing device, a supporting structure may be used to support a print medium while printing thereon. To allow for handling different print media, e.g. print media of different thickness and/or rigidity, the supporting structure may be adjustable. For example, a distance between the supporting structure and a printing unit of the printing device may be adjusted by moving the supporting structure up and down. While moving, the support structure may tilt and may thus become jammed in some cases, e.g. if actuators for moving the support structure are not synchronized.

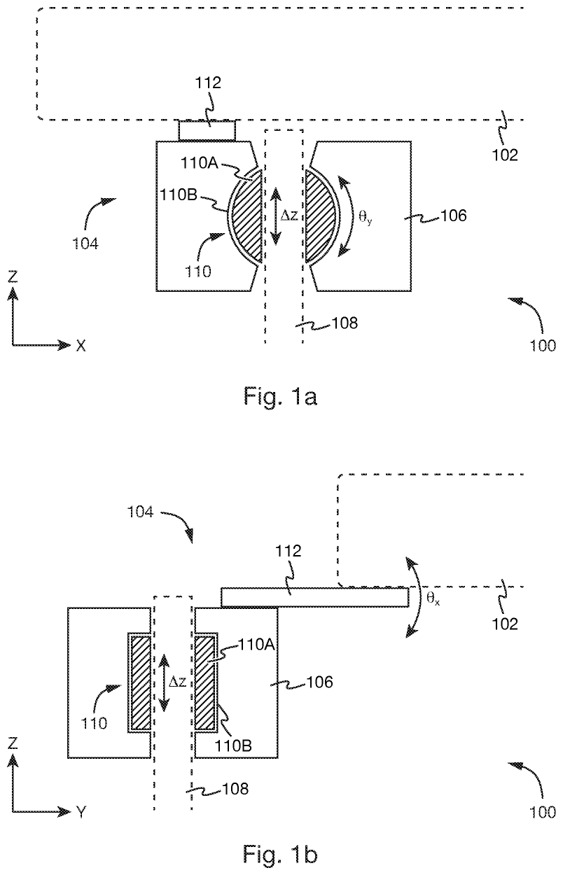

FIGS. 1a and 1b depict schematic illustrations of a mounting system 100 for mounting a print medium supporting structure 102 in a printing device (not shown) according to an example. FIG. 1a shows a cross section of the mounting system 100 in side view along a first axis and FIG. 1b shows a cross section of the mounting system 100 in side view along a second axis. The first axis may for example correspond to the Y axis in FIG. 1b and the second axis may for example correspond to the X axis in FIG. 1a. In the following, the first and second axes may thus also be referred to as the Y and X axis, respectively.

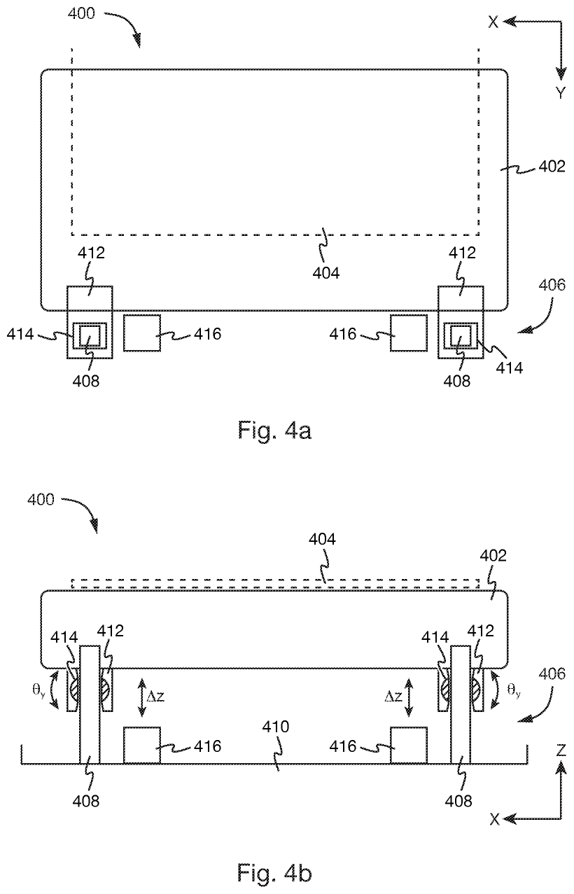

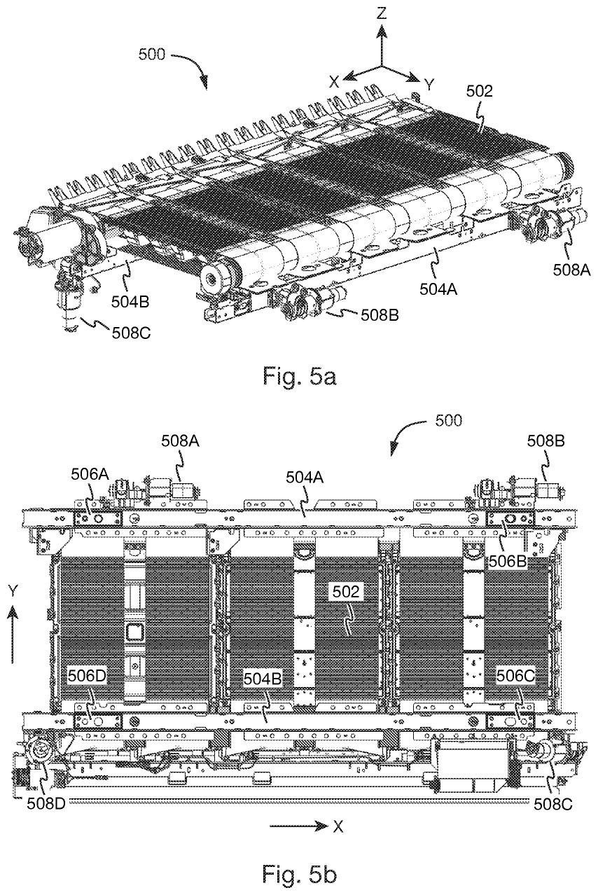

The supporting structure 102 may for example be to support a print medium (not shown) in a printing device, e.g. in a print zone of a printing device such as the printing device 400 described below with reference to FIGS. 4a and 4b. In some examples, the supporting structure 102 may be similar to the supporting structure 402 of the printing device 400 or to the supporting structure 502 of FIGS. 5a, 5b.

The mounting system 100 comprises a carrier assembly 104 that is to carry the supporting structure 102, e.g. by supporting a portion thereof from below. The carrier assembly 104 may be to carry the supporting structure 102 such that a supporting surface of the supporting structure 102 faces upwards for placing the print medium thereon. The carrier assembly 104 comprises a bushing element 106 to movably mount the carrier assembly 104 on a guiding rod 108 in the printing device. The guiding rod 108 may for example be attached to or rigidly coupled to a frame (not shown) of the printing device.

The bushing element 106 comprises a first bushing 110 that is to slidably receive the guiding rod 108. Accordingly, the bushing element 106 can be moved along the guiding rod 108 by sliding the first bushing 110 along the guiding rod 108 as illustrated by the vertical arrow labelled “Δz” in FIGS. 1a, 1b. The first bushing 110 may for example comprise a recess or an opening that is to receive the guiding rod 108, e.g. such that a sidewall of the opening is in contact with the guiding rod 108. In some examples, the opening may be a through hole that extends through the first bushing 110, e.g. such that the guiding rod 108 can extend through the bushing element 106 as illustrated in FIGS. 1a, 1b.

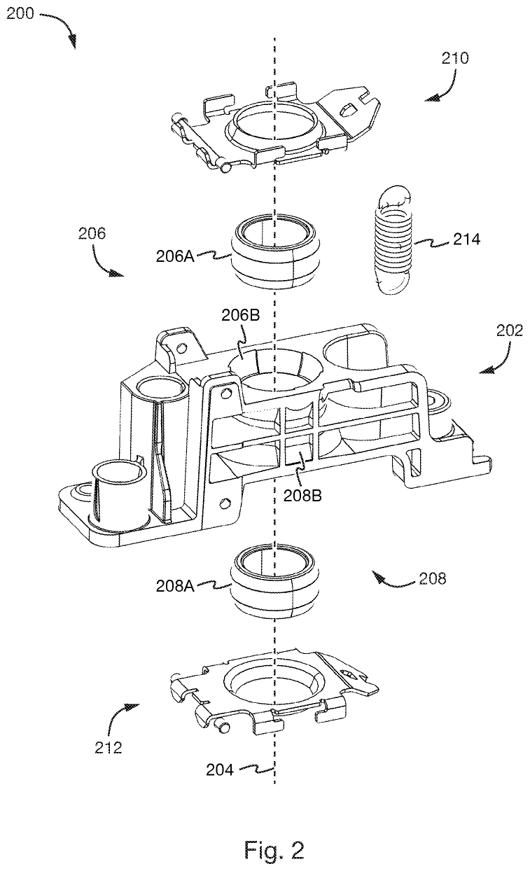

The first bushing 110 is further to allow for a tilting motion of the carrier assembly 104 relative to the guiding rod 108 around the first axis as illustrated by the curved arrow labeled “θ_{y}” in FIG. 1a. The first axis is perpendicular to the guiding rod 108. In the example of FIG. 1a, the first axis corresponds to the direction of view, which in turn may for example correspond to the Y axis of FIG. 1b. The first bushing 110 may for example comprise an articulating member 110A that is arranged in a socket 1106, wherein the articulating member 110A is to rotate relative to the socket 1106 around the first axis. In some examples, the articulating member 110A may be circular disk with two parallel end faces perpendicular to the first axis as illustrated in FIGS. 1a, 1b. The first bushing 110 may not allow for a tilting motion of the carrier assembly 104 relative to the guiding rod 108 around the X axis. In other examples, the first bushing 110 may e.g. be a spherical bushing, for example as described below with reference to FIG. 2, and may also allow fora tilting motion of the carrier assembly 104 relative to the guiding rod 108 around the X axis. The socket 1106 may for example be formed by a frame of the bushing element 106, e.g. as detailed below with reference to FIG. 2.

In some examples, the first bushing 110 may be to allow for a tilting motion of the carrier assembly 106 between a first angle and a second angle relative to a third axis perpendicular to the first axis, e.g. relative to the Z axis of FIGS. 1a, 1b. The first angle may for example be between 0.5° and 5°, in one example between 1° and 3°. The second angle may for example be between −5° and −0.5°, in one example between −3° and −1°. In one example, one of the first and second angles may be 0°. To limit the tilting motion, the bushing element 106 may for example comprise a stopper that is to come in contact with the guiding rod 108 or with the articulating member 110A to prevent further rotation around the first axis. In one example, a frame of the bushing element 106 comprises an opening or a through hole that is to receive the guiding rod 108, wherein a sidewall of the opening or through hole is to come in contact with the guiding rod 108 when the carry assembly 106 is at the first or second angle relative to the Z axis.

The carrier assembly 104 further comprises a flexible element 112 to couple the supporting structure 102 to the carrier assembly 104. The flexible element 112 is to allow for a tilting motion of the supporting structure 102 relative to the carrier assembly 104 around the second axis as illustrated by the curved arrow labeled “θₓ” in FIG. 1b. The second axis is different from the first axis and may for example be perpendicular to the first axis. In some examples, the second axis may also be perpendicular to the guiding rod 108. In the example of FIG. 1b, the second axis corresponds to the direction of view, which in turn may for example correspond to the X axis of FIG. 1a. In some examples, the flexible element 112 is further to prevent a tilting motion of the supporting structure 102 relative to the carrier assembly 104 around the first axis, e.g. such that any tilting motion of the supporting structure 102 relative to the guiding rod 108 around the first axis occurs through the tilting motion of the carrier assembly 104 relative to the guiding rod 108.

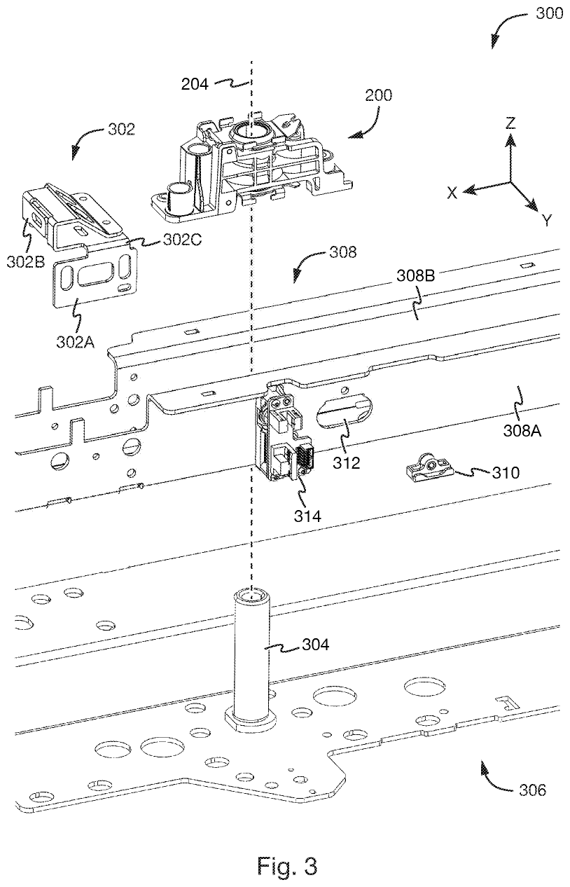

In some examples, the flexible element 112 may be attached to the bushing element 106, e.g. to a frame of the bushing element 106, for example using a screw or a fastener. In other examples, the flexible element 112 may be part of the bushing element 106 and may for example be formed by the frame of the bushing element. In yet other examples, the carrier assembly may comprise a carrier element connecting the bushing element 104 and the flexible element 112, e.g. a carrier beam that the bushing element 104 and the flexible element 112 are attached to as detailed below with reference to FIG. 3. The flexible element 112 may also be attached to the supporting structure, e.g. via a screw or a fastener.

The material, thickness and/or shape of the flexible element 112 may be chosen such that the flexible element 112 is sufficiently rigid to carry the supporting structure, while at the same time allowing for the tilting motion of the supporting structure by bending the flexible element 112. The flexible element 112 may for example comprise a semi-rigid material, e.g. a soft metal such as aluminum or a high-performance plastic such as polyphenylene ether (PPE/PPO) or a PPE blend. In some examples, the flexible element 112 may be a thin sheet metal comprising a hard metal such as steel. The flexible element 112 may be designed such that the flexible element 112 has a reduced stiffness in a direction perpendicular to the second axis, e.g. along the Z axis of FIGS. 1a, 1b. The flexible element 112 may for example be a cantilever, wherein a first end portion of the cantilever is attached to the bushing element 106 or a carrier element of the carrier assembly 104 and a second end portion of the cantilever opposing the first end portion is to carry the supporting structure 102. In other examples, the flexible element 112 may for example comprise a bent portion and may for example have a U-shape or an L-shape, e.g. as detailed below with reference to FIG. 3. In one example, the flexible element 112 may be such that the flexible element 112 bends by an angle of 1° around the Y axis when a tilting force is applied to a portion of the flexible element 112 that is to be coupled to the supporting structure 102, wherein the tilting force is e.g. between 75 N and 200 N.

By allowing for a tilting motion of the supporting structure 102 around two different axes, the mounting system 100 may prevent the supporting structure 102 from becoming jammed, e.g. when moving the carrier assembly 104 along the guiding rod 108. At the same time, the carrier assembly 104 may allow for a precise lateral positioning of the supporting structure 102 relative to the guiding rod 108, for example due to contact between the articulating member 110A and the guiding rod 108 and between articulating member 110A and the socket 110B.

FIG. 2 shows a bushing element 200 for a carrier assembly of a mounting system (not shown) according to an example in an exploded view. The bushing element 200 comprises a frame 202, which may for example comprise a metal such as aluminum or steel and/or a high-performance plastic such as PPE or a PPE blend, for example glass fiber reinforced PPE. The frame 202 comprises a central through hole, in which a guiding rod can be arranged as illustrated by the dashed line 204 in FIG. 2.

The bushing element 200 further comprises a first bushing 206 and a second bushing 208 that are to slidably receive the guiding rod, e.g. such that the guiding rod is in contact with and extends through the first and second bushings 206, 208. Each of the bushings 206, 208 is to allow for a tilting motion of the frame 202 and thus of the carrier assembly relative to the guiding rod around the first axis perpendicular to the guiding rod, i.e. perpendicular to the dashed line 204 in FIG. 2. One of the first and second bushings 206, 208 further provides linear play in a direction perpendicular to the first axis and to the guiding rod. In this way, the two bushings 206, 208 may provide two contact points between the bushing element 200 and the guiding rod, thereby ensuring a precise lateral positioning of the supporting structure in the directions perpendicular to the guiding rod, while also allowing the supporting structure to tilt.

In the example of FIG. 2, each of the bushings 206, 208 comprises an articulating member 206A, 208A that is to be arranged in a respective socket 206B, 208B in the frame 202 of the bushing element 200. The articulating members 206A, 208A and the sockets 206B, 208B each comprise a through hole that is to receive the guiding rod. The sockets 206B, 208B may for example be formed by a sidewall of the through hole of the frame 202. The through holes in the articulating members 206A, 208A may be adapted to a shape of the guiding rod, e.g. such that the guiding rod comes in contact with sidewalls of the through holes when arranged therein, for example to prevent a motion of the articulating members 206A, 206A perpendicular to the guiding rod while allowing a siding motion along the guiding rod. The articulating members 206A, 208A may be formed of a material that is different from the material of the frame 202. This may reduce friction and adhesion between the articulating members 206A,208A and the respective socket 206B, 208B, which may cause wear such as galling. The articulating members 206A, 208A may for example comprise a metal such as brass.

One or both of the bushings 206, 208 may for example be spherical bushings, i.e. the articulating members 206A, 208A may be to tilt or rotate in the respective socket 206A, 208B in two orthogonal directions. In some examples, a surface of the articulating members 206A, 208A facing the respective socket 206B, 208B may correspond to a portion of an outer surface of a sphere and a corresponding surface of the sockets 206B, 208B may correspond to a portion of an inner surface of a sphere. In one example, a center portion of each of the articulating members 206, 208A may comprise an annular protrusion that servers as a stopper for limiting a tilting motion of the frame 202 relative to the guiding rod, e.g. by coming in contact with an upper and lower surface, respectively, of the frame 202. In some examples, one of the first and second bushings 206, 208 may also provide linear play in a direction parallel to the first axis, e.g. to allow for a tilting motion of the carrier assembly relative to the guiding rod around a second axis.

The bushing element 200 further comprises a first retainer plate 210 and a second retainer plate 212 for holding the articulating members 206A, 208A in the respective socket 206B, 208B. For this, the bushing element 200 may for example comprise a spring 214 to press the articulating members 206A, 208A into the respective socket 206B, 208B. In one example, a first end portion of the spring 214 is be attached to the first retainer plate 210 and an opposing second end portion of the spring 214 is attached to the second retainer plate 210, thereby pulling both retainer plates 210 towards the frame 202. In other examples, the bushing element 200 may comprise two springs (not shown), wherein one end portion of each spring is attached to a respective one of the retainer plates 210, 212 and the opposing end portion is attached to the frame 202. Each of the retainer plates 210, 212 may also comprise a through hole that is to receive the guiding rod. In some examples, a diameter of the through holes may be chosen such that retainer plates 210, 212 serve as stoppers for limiting a tilting motion of the frame 202 relative to the guiding rod, e.g. by coming in contact with the guiding rod.

FIG. 3 illustrates a mounting system 300 for mounting a print medium supporting structure (not shown) in a printing device in accordance with an example in an exploded view. The mounting system 300 is similar to the guiding system 100 of FIG. 1 and also comprises a carrier assembly with a bushing element and a flexible element 302 for carrying the supporting structure.

In this example, the carrier assembly comprises the bushing element 200 of FIG. 2 to movably mount the carrier assembly on a guiding rod 304 in the printing device. The guiding rod 304 may for example be a cylindrical guiding rod that is attached to or rigidly coupled to a frame (not shown) of the printing device. In the example of FIG. 3, the guiding rod 304 is attached to a fixed beam 306, which in turn may e.g. be attached to or part of the frame of the printing device. The guiding rod 304 may for example comprise a metal such as steel.

The carrier assembly further includes a carrier beam 308 that the bushing element 200 and the flexible element 302 are to be attached to, e.g. using screws or fasteners. Accordingly, by sliding the bushings 206, 208 of the bushing element 200 along the guiding rod 304, the carrier beam 308 may be moved relative to the fixed beam 304. In some examples, the mounting system 300 may provide between 5 mm and 50 mm, in one example between 10 mm and 30 mm of travel along the guiding rod 304 for the carrier beam 308. The bushings 206, 208 further allow for a tilting motion of the carrier beam 308 relative to the guiding rod 304 around the first axis. The first axis may for example correspond to the Y axis of FIG. 3 and may e.g. be perpendicular to a longitudinal direction of the carrier beam 308, which may correspond to the X axis of FIG. 3. In some examples, the bushing element 200 may allow for a tilting range between 0.5° and 10°, in one example between 1° and 3°.

The carrier beam 308 has two opposing sidewalls 308A, 308B, wherein the bushing element 200 is to be arranged between the opposing sidewalls 308A, 308B. The carrier beam 308 may for example have a U-shaped cross section with a bottom wall extending between the sidewalls 308A, 308B, wherein the bushing element 200 may e.g. be attached to the bottom wall. In one example, a height of the sidewalls 308A, 308B is larger than a height of the bushing element 200 in a direction parallel to the guiding rod 304 such that the bushing element 200 can be arranged on the bottom wall without protruding above the edges of the sidewalls 308A, 308B, e.g. for placing a lid on the U-shaped carrier beam 308. In some examples, the carrier beam 308 may be a hollow tube and may for example have a rectangular cross section, wherein the bushing element 200 may be arranged inside the tube. The carrier beam 308 may for example comprise a metal such as aluminum.

In some examples, the carrier assembly comprises a pair of bushing elements (not shown), e.g. similar to the bushing element 200, to movably mount the carrier beam 308 on a pair of guiding rods, for example as detailed below with reference to FIGS. 4 and 5. The bushing elements may for example be attached to opposing end portions of the carrier beam 308. Each of the bushing elements may be to slidably receive a respective one of the guiding rods while allowing for a tilting motion of the carrier beam 308 relative to the guiding rod. The tilting motions may occur around parallel axes perpendicular the guiding rods, e.g. axes parallel to the Y axis of FIG. 3. This may allow for independently moving each end portion of the carrier beam 308 without the bushing elements becoming jammed along the guiding rods.

In some examples, the mounting system may comprise two such carrier assemblies that are to carry opposite edge portions of the supporting structure, e.g. as described below with reference to FIGS. 5a, 5b.

The carrier assembly further comprises the flexible element 302 to couple the supporting structure to the carrier assembly. The flexible element 302 comprises an L-shaped bracket with two leg portions 302A, 302B that extend at an angle to each other, e.g. at a 90° angle. The first leg portion 302A may be attached to the carrier beam 308, e.g. to one of the sidewalls 308A, 308B. The second leg portion 302B may be attached to the supporting structure. In some examples, the first leg portion 302A may be attached to the carrier beam 308 such that a corner portion 302C of the L-shaped bracket, which connects the leg portions 302A, 302B, extends perpendicular to the first axis, e.g. parallel to the X axis of FIG. 3. Thereby, the L-shaped bracket may allow for a tilting motion of the supporting structure relative to the carrier assembly around the second or X axis.

In some examples, the corner portion 302C may be structurally weaker than adjacent portions of the L-shaped bracket, e.g. adjacent parts of the leg portions 302A, 302B. For example, a width of the corner portion 302C, e.g. a width perpendicular to the Y axis and to the guiding rod 304, may be smaller than the corresponding width of the adjacent portions. The corner portion may for example comprise a recess extending parallel to the X axis as illustrated in FIG. 3. Additionally or alternatively, a thickness of the corner portion 302C may be smaller than that of the adjacent portions.

In some examples, the second leg portion 302B may be to also provide elasticity to allow for a tilting motion of the supporting structure. The second leg portion 302B may for example comprise a bend portion and may e.g. have a Ushape as illustrated in FIG. 3. The second leg portion 302B may further comprise cutouts or holes to reduce its structurally integrity.

The carrier assembly of the mounting system 300 further comprises a cam follower 310 that is to be engaged with a cam shaft (not shown) coupled to an actuator, e.g. for moving the carrier assembly and thereby the supporting structure along the guiding rod 304. For this, the cam follower 310 may be rigidly connected to the bushing element 200 and to the flexible element 302. In the example of FIG. 3, the cam follower 310 is to be attached to the sidewall 308A of the carrier beam, e.g. by arranging the cam follower 310 in a cutout 312 in the sidewall 308A. The carrier assembly further comprises a position detector 314 that is to determine a position of the carrier assembly along the guiding rod 304. The position detector 314 may for example comprise an encoder that is attached to the carrier beam and is to detect motion of the carrier beam 308 along an encoder strip.

FIGS. 4a and 4b depict a schematic illustration of a printing device 400 according to an example. In FIG. 4a, the printing device 400 is shown in top view. FIG. 4b depicts a cross section of the printing device 400 in side view. The direction of view of FIG. 4a may for example correspond to the Z axis of FIG. 4b and the direction of view of FIG. 4b may for example correspond to the Y axis of FIG. 4a.

The printing device 400 may be to deposit a printing fluid on a print medium 404. The printing device 400 may for example be an inkjet printer, e.g. a large-format printer, that is to deposit ink on the print medium 404, wherein the print medium 404 may e.g. be a flexible print medium such as paper or textile and/or a rigid print medium such as cardboard, wood, plastic, or metal. For this, the printing device 400 may for example comprise a printhead (not shown) that is moveable along a print head path above the print medium 404. In other examples, a different printing technology may be used. The printing device 400 may for example be a three-dimensional (3D) printer that is to deposit a binding agent on a print medium 404 in the form of build material.

The printing device 400 comprises a supporting structure 402 to support the print medium 404 in a print zone of the printing device 400. The print zone may for example be a zone in the printing device 400, in which the printing fluid is deposited on the print medium 404. In some examples, the supporting structure 402 may comprise a platen (not shown) for mechanically supporting the print medium 404. The support structure 402 may also comprise a ventilation system (not shown), e.g. to press the print medium 404 against the platen by drawing air through openings in the platen. In some examples, the support structure 402 may comprise a transport system (not shown) for advancing the print medium 404 along a printing advance direction, which may e.g. coincide with the Y axis of FIG. 4a. The transport system may for example comprise a transport belt for moving the print medium 404, e.g. as shown in FIGS. 5a, 5b. In other examples, the printing device 400 may comprise a transport system that is independent of the supporting structure 402.

The printing device 400 further comprises a guiding system 406 that is to move the supporting structure 402 in a direction perpendicular to the printing advance direction, e.g. along the Z direction of FIG. 4b. The guiding system 406 comprises at least two guiding rods 408 that are connected to a frame 410 of the printing device 400. The guiding rods may for example be part of the frame 410, may be attached to the frame 410, or may be rigidly coupled to the frame 410, e.g. through a fixed beam as in the mounting system 300 of FIG. 3. The guiding rods 408 arranged near respective corners of the supporting structure 402 and may for example be cylindrical rods similar to the guiding rod 304 of FIG. 3 or rods with a rectangular cross section as illustrated in FIG. 4a.

The guiding system 406 further comprises at least two connecting members 412 attached to the supporting structure 402. Each of the connecting members 412 comprises an articulating slide bearing 414 that is to slidably receive a respective one of the guiding rods 408 such that the supporting structure 402 is tiltable relative to the respective guiding rod 408 around a first axis perpendicular to the guiding rod 408. The first axis may for example correspond to the Y axis of FIG. 4a. In some examples, one or both of the connecting members 412 may be similar to one of the bushing elements 106 and 200 described above. For example, one or both of the articulating slide bearings 414 may be a bushing similar to the bushing 110 shown in FIG. 1a, 1b or to the bushing 206 or 208 shown in FIG. 2. In another example, one or both of the articulating slide bearings 414 may comprise two bushings similar to the bushings 206, 208 of FIG. 2. In some examples, one or both of the connecting members 412 may be part of a carrier assembly, e.g. a carrier assembly similar to the one of the mounting system 100 or 300.

The guiding system 406 further comprises at least two actuators 416 to move a respective one of the connecting members 414 along the respective guiding rod 408. The actuators 416 may for example be electric motors. Each of the actuators 416 may be coupled to a cam shaft (not shown), e.g. via a worm drive or a gear drive. The cam shaft may for example be engaged with the respective connecting member 414 or with the supporting structure 402. In one example, the cam shaft is engaged with a cam follower, wherein the cam follower may for example be arranged on or attached to the supporting structure 402, e.g. attached to a carrier element of the supporting structure 402 similar to the carrier beam 308 of the mounting system 300 of FIG. 3. The printing device 400 may comprise a controller (not shown) that is to control the actuators 416. In some examples, the controller may be to control the actuators 416 independently, e.g. such that the connecting members 414 are moved along the respective guiding rod 408 independently of each other. In some examples, the movement of the actuators 416 may not be synchronized.

In some examples, the printing device 400 further comprises a position detector (not shown) that is to detect the position of one of the connecting members 412 along the respective guiding rod 408. The position detector may for example be similar to the position detector 314 of the mounting system 300 and may e.g. also comprise an encoder. Additionally or alternatively, the position detector may for example comprise a photoelectric relay, an inductive or capacitive sensor, and/or a magnetic sensor that may e.g. be to detect position markers associated with certain position along the guiding rod 408. In some examples, the printing device 400 comprise a respective position detector for each of the connecting members 412.

In some examples, the guiding system 406 may comprise more than two guiding rods, two connecting members, and/or two actuators. The printing device 400 may for example comprise four guiding rods, four connecting members, and four actuators, wherein each guiding rod is arranged near or adjacent to a respective corner of the supporting structure, e.g. as detailed in the following with reference to FIG. 5. Furthermore, the guiding system 406 may comprise other elements such as a carrier assembly including a carrier element such as a carrier beam or a flexible element to couple the supporting structure to a connecting member or to the carrier assembly, e.g. as described above. The guiding system 406 or a part thereof may for example be similar to one of the mounting systems 100 and 300.

FIGS. 5a and 5b illustrate an assembly 500 comprising a supporting structure 502 and a guiding system for use in a printing device according to an example, e.g. in the printing device 400. FIG. 5a shows a perspective view of the assembly 500 and FIG. 5b shows the assembly 500 in top view, for example when viewed along the Z axis of FIG. 5a.

The supporting structure 502 may for example be similar to the supporting structure 402 described above. In some examples, as illustrated in FIGS. 5a, 5b, the supporting structure 502 may comprise a platen and a transport belt for moving a print medium (not shown) arranged on the supporting structure 502 along a printing advance direction, which may for example be aligned with the Y axis of FIGS. 5a, 5b. The transport belt may for example form a supporting surface, on which the print medium can be placed. In some examples, the supporting structure may also comprise supporting ribs extending below the transport belt, e.g. parallel to the Y axis of FIGS. 5a, 5b. In one example, a width of the supporting structure along the X axis is between 0.5 m and 2 m and a length of the supporting structure along the Y axis is between 0.25 m and 1 m.

The guiding system is to move the supporting structure 502 in a direction perpendicular to the printing advance direction, e.g. along the Z axis of FIG. 5a. The guiding system comprises a pair of carrier beams 504A, 504B, which are arranged adjacent to opposing edge portions of the supporting structure 502 to carry the supporting structure 502. The carrier beams 504A, 504B extend perpendicular to the printing advance direction, e.g. parallel to the X axis of FIGS. 5a, 5b, which may e.g. correspond to a scanning direction of a print head of the printing device. The carrier beams 504A, 504B may for example be similar to the carrier beam 308 of the mounting system 300 and may for example be coupled to the supporting structure 502 via flexible elements such as the flexible element 112 or an L-shaped connector such as the L-shaped bracket 302, e.g. to allow for a tilting motion of the supporting structure 502 around the X axis. In some examples, the carrier beams 504A, 504B are coupled to the supporting structure 502 through a plurality of L-shaped connectors. A leg of each of the L-shaped connectors may for example extend parallel to the first of Y axis, e.g. such that a corner portion of the L-shaped connectors extends along the X axis.

The guiding system further comprises four connecting members 506A, 506B, 506C, 506D that are attached to the supporting structure 502, e.g. via the pair carrier beams 504A, 504B. Each of the connecting members 506A-506D comprises an articulating slide bearing that is to slidably receive a respective guiding rod (not shown) such that the supporting structure 502 is tiltable relative to the respective guiding rod around the Y axis, which is perpendicular to the guiding rod, e.g. as described above. In one example, each of the connecting members 506A-506D may be similar to the bushing element 200.

The position of the four connecting members 506A-506D along the respective guiding rod defines the position and orientation of the supporting structure 502. Due to the articulating slide bearings in the connecting members 506A-506D, the supporting structure 502 may tilt around the Y axis without becoming jammed such that each of the connecting members 506A-506D may be moved independently along the respective guiding rod. For this, the assembly 500 comprises four actuators 508A, 5086, 508C, 508D, each of which is associated with a respective one of the connecting members 506A-506D. Each of the actuators 508A-508D may for example be coupled to a cam shaft that is engaged with a cam follower attached to one of the carrier beams 504A, 504B in the vicinity of the respective connecting member 506A-506D, e.g. as described above with reference to FIG. 3.

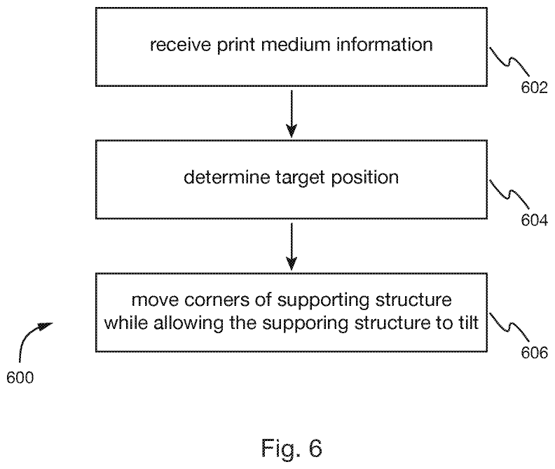

FIG. 6 shows a flow chart of a method 600 of operating a printing device according to an example. The method 600 may be used for operating a printing device that comprises a supporting structure having a supporting surface to support a print medium and an adjustment system to adjust a position of the supporting structure. The supporting structure may for example be similar to one of the supporting structures 102, 402 and 502 described above. The adjustment system may for example be similar to one of the mounting systems 100 and 300, to the guiding system 406 or to the guiding system of the assembly 500. In the following, the method 600 is described using the printing device 400 and the assembly 500 as an example for illustration purposes.

The method 600 comprises, at block 602, receiving information pertaining to a type of the print medium 404. The information may for example comprise a thickness of the print medium 404, a rigidity of the print medium 404, a porosity of the print medium 404, and/or a material of the print medium 404. The information may for example be received by a controller of the printing device 400 or by a computing device such as a computer in communication with the printing device 400. The information may e.g. be received by the controller from a personal computer of a user, who may for example select the type of the print medium 404 provided to the printing device 400 using a driver or software for the printing device 400. Additionally or alternatively, the printing device 400 may comprise a sensor that is to determine the respective information or a part thereof.

The method 600 further comprises, at block 604, determining a target position for each corner of the supporting structure 402, 502 based on the received information, e.g. using the controller and/or the computing device. For example, the target positions may be adapted to the type of the print medium 404, e.g. to the thickness of the print medium 404, for example to ensure a proper distance between the print medium 404 and a printing unit of the printing device 400 for depositing a printing fluid on the print medium 404. In one example, the controller and/or the computing device may store a look-up table associating a plurality of types and/or thicknesses of print media with respective target positions. The target position may for example be defined relative to the printing unit or to a fixed point within the printing device 400, e.g. a part of the frame 410 or a guiding rod 408 associated with the respective corner.

At block 606, the corners of the supporting structure 402, 502 are moved to the respective target position. While moving the corners, the supporting structure 402, 502 is allowed to tilt along a first direction parallel to the supporting surface. Tilting along the first direction may for example comprise a tilting motion around a first axis perpendicular to the first direction and parallel to the supporting surface, e.g. around the Y axis of FIGS. 4a, 5a. Moving the corners may comprise sliding a bearing along a guiding rod 408 connected to the frame 410 of the printing device 400. The bearing may for example be an articulating slide bearing such as the articulating slide bearing 412, the bushing 110 or the bushing 206. In some examples, the bearing may comprise a pair of bushings, e.g. spherical bushings such as the bushings 206, 208. The corners may be moved independently of each other, e.g. using non-synchronized actuators such as the actuators 508A-508D.

In some examples, the supporting structure 402, 502 may also be allowed to tilt along a second direction different from the first direction while moving. The second direction may also be parallel to the supporting surface and may for example correspond to the Y direction of FIGS. 4a, 5a, wherein tilting along the second direction may comprise a tilting motion around a second axis perpendicular to the second direction and parallel to the supporting surface, e.g. around the X axis of FIGS. 4a, 5a. Tilting the supporting structure 402, 502 along the second direction may for example comprise bending a flexible element carrying the supporting structure 402, 502, e.g. a flexible element such as the flexible element 112 or the flexible element 302. Additionally or alternatively, this may comprise rotating an articulating member of a spherical bushing such as the bushing 206 and/or 208.

The description is not intended to be exhaustive or limiting to any of the examples described above. The mounting system, the printing device and the method of operating a printing device disclosed herein can be implemented in various ways and with many modifications without altering the underlying basic properties.

1. A mounting system for mounting a print medium supporting structure in a printing device, the mounting system comprising a carrier assembly that is to carry the supporting structure, wherein the carrier assembly comprises:
a bushing element to movably mount the carrier assembly on a guiding rod in the printing device, wherein the bushing element comprises a first bushing that is to slidably receive the guiding rod and to allow for a tilting motion of the carrier assembly relative to the guiding rod around a first axis perpendicular to the guiding rod; and
a flexible element to couple the supporting structure to the carrier assembly, wherein the flexible element is to allow for a tilting motion of the supporting structure relative to the carrier assembly around a second axis different from the first axis.

2. The mounting system of claim 1, wherein the bushing element comprises a second bushing that is to slidably receive the guiding rod and to allow for a tilting motion of the carrier assembly relative to the guiding rod around the first axis, wherein one of the first and second bushings further provides linear play in a direction perpendicular to the first axis and to the guiding rod.

3. The mounting system of claim 1, wherein the first bushing is a spherical bushing formed by an articulating member arranged in a socket in a frame of the bushing element, wherein the articulating member and the socket each comprise a through hole that is to receive the guiding rod.

4. The mounting system of claim 3, wherein the bushing element further comprises a retaining plate and a spring that are to press the articulating member against the socket.

5. The mounting system of claim 1, wherein the carrier assembly includes a carrier beam and the mounting system comprises two such carrier assemblies that are to carry opposing edge portions of the supporting structure, wherein a pair of bushing elements is attached to each of the two carrier beams to movably mount the respective carrier beam on a pair of guiding rods.

6. The mounting system of claim 5, wherein each of the carrier beams has a Ushaped cross section having two opposing sidewalls and wherein the bushing elements are arranged between the opposing sidewalls of the respective carrier beam.

7. The mounting system of claim 1, wherein the flexible element comprises an L-shaped bracket and a corner portion of the L-shaped bracket extends perpendicular to the first axis.

8. The mounting system of claim 7, wherein the corner portion of the L-shaped bracket is structurally weaker than adjacent portions of the L-shaped bracket.

9. The mounting system of claim 1, wherein the carrier assembly comprises a cam follower that is to be engaged with a cam shaft coupled to an actuator, wherein the cam follower is rigidly connected to the bushing element and to the flexible element.

10. A printing device comprising:
a supporting structure to support a print medium in a print zone of the printing device; and
a guiding system that is to move the supporting structure in a direction perpendicular to a printing advance direction;
wherein the guiding system comprises:
at least two guiding rods connected to a frame of the printing device and arranged near respective corners of the supporting structure;
at least two connecting members attached to the supporting structure, wherein each of the connecting members comprises an articulating slide bearing that is to slidably receive a respective one of the guiding rods such that the supporting structure is tiltable relative to the respective guiding rod around a first axis perpendicular to the guiding rod; and
at least two actuators to move a respective one of the connecting members along the respective guiding rod.

11. The printing device of claim 10, wherein each actuator is coupled to a cam shaft that is engaged with a cam follower on the supporting structure.

12. The printing device of claim 10, further comprising a position detector to detect the position of one of the connecting members along the respective guiding rod.

13. The printing device of claim 10, wherein the connecting members are attached to a pair of carrier beams coupled to the supporting structure through a plurality of L-shaped connectors, wherein a leg of the L-shaped connectors extends parallel to the first axis.

14. A method of operating a printing device, wherein the printing device comprises:
a supporting structure having a supporting surface to support a print medium; and
an adjustment system to adjust a position of the supporting structure,
the method comprising:
receiving information pertaining to a type of the print medium;
determining a target position for each corner of the supporting structure based on the received information; and
moving the corners of the supporting structure to the respective target position while allowing the supporting structure to tilt along a first direction parallel to the supporting surface.

15. The method of claim 14, wherein moving the corners of the supporting structure comprises sliding an articulating slide bearing attached to the supporting structure along a guiding rod connected to a frame of the printing device.
